(19) United States
(12) Patent Application Publication
(10) Pub. No.: US 2011/0243688 A1
(43) Pub. Date: Oct. 6, 2011

(54) CLAMP FOR FASTENING DEVICE TO A STRUCTURE

(76) Inventors: Jean Luc Klein, Ringendorf (FR); Michel Kuhm, Ingwiller (FR)

(21) Appl. No.: 13/126,849

(22) PCT Filed: Nov. 4, 2009
(86) PCT No.: PCT/EP09/07910

§ 371 Date: May 31, 2011

(30) Foreign Application Priority Data
Nov. 4, 2008 (FR) 08/06133

(51) Int. Cl. F16B 21/08

(52) U.S. Cl. 411/510

(57) ABSTRACT

A retaining clip (1) for fixing an equipment on a structure, includes a base member (4), from which an anchoring end piece (3) extends with a first portion (80) which has a general shape tapered towards a free end opposite to the base member (4). The first portion (80) continues into a second portion (90) which substantially forms a fixation constriction (9) near the base member (4). An elastically deformable sliding surface (20) extends between the first portion (80) and the second portion (90), with which it is connected via a first contact bend and a second contact bend, respectively, which are separate from each other and each protrude at least on a part of their length on the one hand with respect to the sliding region (20) and on the other hand with respect to the first portion (80) or to the second portion (90), respectively.

### RELATED APPLICATIONS

This application corresponds to PCT/EP2009/007910, filed Nov. 4, 2009, which claims the benefit of French Application No. 08/06133, filed Nov. 4, 2008, the subject matter, of which is incorporated herein by reference in their entirety.

### BACKGROUND OF THE INVENTION

The present invention relates to a retaining clip for fixing an equipment on a structure, comprising a base member, from which an anchoring end piece extends with a first portion which has a general shape tapered towards a free end opposite to the base member, wherein the first portion continues into a second portion which substantially forms a fixing constriction near the base member.

In particular, but not exclusively, the invention relates to the field of the fixation of panels of a technical kind and/or for providing a decorative trim on a structure in motor vehicles.

The invention is concerned with fixing a trim panel with a plurality of clips which each have an anchoring end piece and a head on the one and on the other side of a base member, which head is provided to achieve a firm connection of the trim panel, on a structural element which in general is a body element of the vehicle. The trim panel includes a number of openings in each of which a head of a clip is pre-mounted, before the trim panel is arranged against the structural element which includes a number of openings which are positioned such that they coincide with the clips of the trim panel, and into which the anchoring end pieces are inserted when the panel is pressed against the holder.

In the industry and in particular in the automotive industry a high and increasing demand of clips exists, which are provided to mount objects such as trim panels, cables or strips on perforated thin panels. These clips include an elastic anchoring end piece which can be inserted into an opening, which frequently is round and formed in the structural element, with force or by locking into place. The anchoring end piece of this kind of clip must have mechanical and dimensional features such that it can be pressed into the opening without damaging the structural element, wherein, when inserted, this clip however must offer a high resistance to withdrawal.

Such clips are known in very different embodiments. In general, the clip includes an anchoring end piece and a head, which preferably are separated by a base member. The head and the anchoring end piece generally are located in one and the same longitudinal axis. The base member serves to ensure a tightness between the outer region and the closed volume defined by the trim panel and the structural element frequently by means of a compliant ring-shaped apron or an equivalent device.

A particular shape of the head is not claimed in the present invention, but this shape can be adapted depending on the particularity which is suitable for the use for which it is intended.

From the document FR 2 789 454 a particular shape of an anchoring end piece is known, which includes a rigid web which is connected with the base member and is tapered and carries two flexible aprons. The same are bent and any cross-section of the end piece has an S-shape which is symmetrical with respect to a longitudinal axis of the end piece. The external shape of the aprons substantially is double-conical on the one and on the other side of a plane vertical to this axis.

When the anchoring end piece is pressed into a corresponding opening of the panel, the cooperation between the circumference of the opening and the outer surfaces formed by the aprons of the end piece leads to the fact that the aprons are bent by elastic deformation, which causes the displacement of their free end in direction of the web.

Such clip has several disadvantages. The main disadvantage is the high force which must be applied due to the resistance of the holder, in order to achieve the bending of the aprons when inserting the clip, which makes inserting the trim panel more difficult. To reduce the bending load to be exerted on the aprons in the case of such clips, the thickness of their walls was reduced as far as possible, whereby a fragility of the clip was produced in the regions which cooperate with the circumference of the openings.

This fragility is fundamental for a clip which must be mounted and demounted several times during the service life of a vehicle. These mounting and demounting operations lead to the wear of the edge at the level of the connecting plane of the double cone. This wear is inevitable when the clip is made of plastics and the structure consists of sheet metal. For this reason, the outside diameter of the clip, which should cooperate with the opening of a panel, is reduced very quickly, which is disadvantageous for a good retention of the clip in the opening.

### SUMMARY OF THE INVENTION

The object of the invention is to eliminate the disadvantages of the prior art.

For this purpose, the invention relates to a retaining clip for fixing an equipment on a structure, comprising a base member which itself has a head or is designed such that it can receive a head, wherein on the side opposite to the head proceeding from the base member an anchoring end piece extends with a first portion which has a general shape tapered towards a free end opposite to the base member, wherein the first portion continues into a second portion which substantially forms a fixation constriction near the base member, characterized in that an elastically deformable sliding surface extends between the first portion and the second portion, with which it is connected via a first contact bend and a second contact bend, respectively, which are separated from each other and each protrude at least on a part of their length on the one hand with respect to the sliding region and on the other hand with respect to the first portion or the second portion, respectively.

The advantages of the shape provided to the clip in accordance with the invention lead to a considerable improvement of the wear resistance of the clip in different operations for insertion into and withdrawal from the structural element. This clip according to the invention has a sliding region which is a portion which extends substantially paraxially to the direction of insertion opposite to the maximum insertion force, and the wear merely occurs at the level of two edges which define this sliding surface, whose height is maintained.

### BRIEF DESCRIPTION OF THE DRAWINGS

Further features and advantages of the invention become apparent from the following detailed description of non-limiting embodiments of the invention with reference to the attached drawings, in which:

FIG. 1 schematically shows a top view of a clip according to the invention;

FIG. 2 schematically shows a sectional view of the clip of FIG. 1 along a longitudinal plane and in direction AA;

FIG. 3 schematically shows a section of the clip of FIG. 1 along a longitudinal plane and in direction BB;

FIG. 4 schematically shows an end view of the clip of FIG. 1;

FIG. 5 schematically shows a segment of a cross-section of an apron which includes the clip of FIG. 1;

FIG. 6 analogous to FIG. 1, schematically and in a partial view shows a segment of a clip in a design variant;

FIG. 7 analogous to FIG. 1, schematically and in a partial view shows a clip in a further design variant;

FIG. 8 schematically and in a partial view shows a section analogous to FIG. 2 of the clip of FIG. 7.

### DESCRIPTION OF EXEMPLARY EMBODIMENTS

A first embodiment of the invention is illustrated in the Figures.

The invention relates to a retaining clip 1 for fixing an equipment on a structure, in particular a vehicle interior equipment, which generally consists of a shaped plastic, is formed in one piece and such that it can carry an attached or formed-on circumferential seal. This clip 1 is provided to be partly inserted into an opening of a structural element via a head 2 and to be connected with an equipment such as a trim panel.

This clip 1 includes a base member 4. The same itself has a head 2 or is formed such that it can receive such head 2. Proceeding from this base member 4 an anchoring end piece 3 extends in a first direction on the side opposite to the head 2, which includes a first portion 80 which has a general shape tapered towards a free end 8 opposite to the base member 4.

This first portion 80 continues into a second portion 90, which substantially forms a fixation constriction 9 near the base member 4.

In accordance with the invention, an elastically deformable sliding surface 20 extends between the first portion 80 and the second portion 90, with which it is connected via a first contact bend 21 and a second contact bend 22, respectively. This first contact bend 21 and second contact bend 22 are separated from each other, wherein they each protrude at least on a part of their length on the one hand with respect to the sliding region 20 and on the other hand with respect to the first portion 80 or the second portion 90, respectively.

It should be appreciated that in operations for inserting and withdrawing the clip according to the invention with respect to an opening of a structure the wear occurs at the level of the protruding edges, which thus protect the actual sliding region 20 and provide for a reduced wear.

In a particular embodiment, the sliding surface 20 is frustoconical or also included in a frustoconical envelope with an opening angle γ. This angle γ preferably is very small and in particular chosen smaller than the opening angle α of a frustoconical envelope which is applied to the first contact bend 21 and is tangent to the first portion 80.

The angle γ in particular is chosen smaller than 40 degrees.

The first contact bend 21 and the second contact bend 22 preferably are contained in mutually spaced, parallel planes 30, 31 and with the same each define a cross-section of the anchoring end piece 3, which corresponds to its maximum cross-section.

The first contact bend 21 and the second contact bend 22 preferably are parallel to each other. In a preferred design, the anchoring end piece 3 is elastically deformable and by deformation in one of its positions adopts a sliding region 20 which supports on a cylindrical surface, wherein this position in the deformed condition then corresponds to the optimum position for inserting or withdrawing the end piece 3 with respect to an opening of a structure.

In a preferred design, the anchoring end piece 3 extends parallel to an axis 33 which corresponds to its direction for insertion or withdrawal with respect to an opening of a structure. In a preferred variant, the sectional line between the sliding surface 20 and at least one plane, which extends through the axis 33, is parallel to the same.

As shown in the Figures, for a simplified realization, in particular by injection molding, and to achieve particularly low costs, the anchoring end piece 3 according to a preferred embodiment extends parallel to an axis 33, and the tapered portion 80 includes a plane of symmetry 32 which extends through this axis 33, or includes an axis of symmetry which coincides with the same.

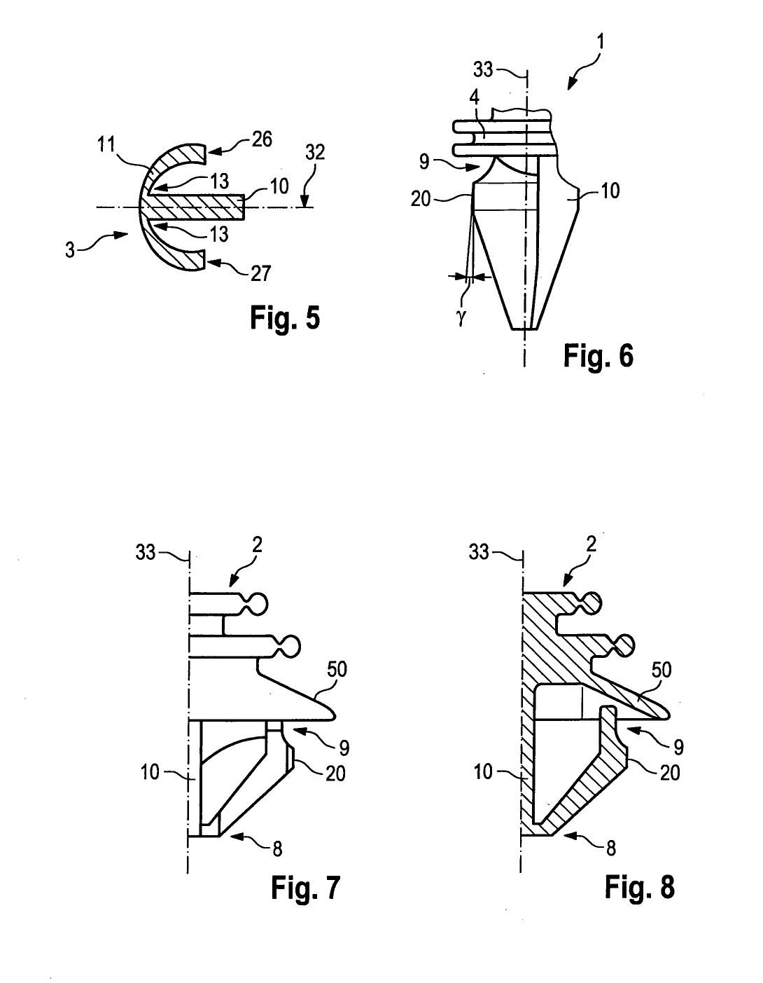

As shown in FIG. 5, the anchoring end piece 3 of a preferred variant extends parallel to an axis 33, and each cross-section of the end piece 3 has the shape of two joined U.

As shown in all Figures, the end piece 3 preferably includes a web 10 which proceeds from the base member 4 and extends to the free end 8, from where a halfway circumferential apron 11 extends. This web 10 has a thickness which is sufficient to impart a rigidity to the anchoring end piece 3 and provide for pressing the same into the opening of a structural element, without the end piece 3 yielding or being bent. In a particular design variant the surfaces of this web 10 are flat, and in a preferred design the web 10 is flat, i.e. its two sides with the greatest surface area are parallel.

The apron 11 is formed such that it can take at least one first, collapsed position in which it can pass through an opening of a structure, and a second, extended position in which it is blocked by this opening, with the structure then lying in the constriction region 9.

The apron 11 has a concave bottom, extends lengthwise in a direction parallel to an axis 33 and preferably is only connected with the web 10, so that it can be deformed elastically in a direction radial to this axis 33.

As shown in FIG. 5, the halfway circumferential apron 11 in accordance with the invention preferably includes at least one bending region 13 near the web 10, whose cross-section, with each cross-section, i.e. vertical to a direction in which the anchoring end piece 3 extends, is smaller than the remaining apron 11. In a particular variant, this bending region 13 is that region in which the thickness of the apron 11 is smallest. The apron 11 has at least one free end 26, which is attached neither to the web 10 nor to the base member 4, and depending on its geometry the apron 11 can have a second end 27 or more ends.

For this reason, a smaller radial force is required for bending the apron 11 to the web 10, with a good tear resistance being maintained in longitudinal direction of the clip 1. Since the deforming region, in particular the bending region 13, thus is moved near the connection of the apron 11 with the web 10, the apron can be more massive on the other side of the bending region when approaching its free end or its free ends 26, 27, without impairing the desired compliance for an easy assembly. In a preferred embodiment of the invention, to provide for an easier deformation of the apron 11 when inserting the clip 1 into the structural element, the thickness of the apron 11 thus increases from at least one bending region 13, preferably near the web 10, to at least one free end 26 of this apron 11 and to each end 26, 27, if it has several ends. This end then is wide enough to arrange injection points, which are required to obtain very good material forming conditions, whereby independent of the thickness of the legs in the bending region or in the bending regions a better quality of the parts thus produced is ensured.

In its portion with the sliding surface 20, the apron 11 preferably is thicker than outside this sliding surface.

As shown in FIGS. 7 and 8, the anchoring end piece 3 of a preferred design variant extends parallel to an axis 33, and at the level of the sliding surface 20 the apron 11 includes an outer and an inner profile, which at each cross-section of the apron 11 extend through a plane extending through the axis parallel to this axis 33, wherein the inner and the outer profile together define the region with the strongest cross-section of the apron 11. This preferred design allows to have a region with constant cross-section, which provides for a good distribution of forces.

In accordance with a preferred embodiment of the invention, each cross-section of the apron 11 has the shape of two joined U, and the common leg of the two U coincides with the web 10.

As shown in FIG. 4 or 5, which illustrate the apron in the free condition, the contour of the apron 11 preferably is substantially elliptical at each cross-section. The major axis of this ellipse, which corresponds to the maximum distance between two points of the apron 11 which lie on the one and on the other side of the web 10, has a greater dimension than that of the opening with which the clip 1 should cooperate. On the other hand the minor axis, which corresponds to the maximum distance between a point of the apron 11 which lies on the extension of the web 10 and the end of this web 10, which is opposite to this point, has a smaller dimension than that of the opening. When exerting a force on the apron 11 during an insertion or withdrawal, the ends of the major axis tend to approach each other under the influence of the radial component of this force and the ellipse approaches the circle which is formed at the minor axis when the sliding region 20 approaches the opening. After passing over the opening, the forces exerted on the apron 11 decrease, and the same tends to again assume its flattened shape in the free condition.

In an advantageous embodiment, the free end 8 of the anchoring end piece 3 has the shape of a tip 5, in particular with a profile of a conical envelope with an opening angle α, in order to simplify the insertion of the clip 1 and limit the stresses which then are exerted on the same. The apron 11 then unfolds proceeding from this tip 5. The opening angle α of this cone preferably is smaller than 40 degrees.

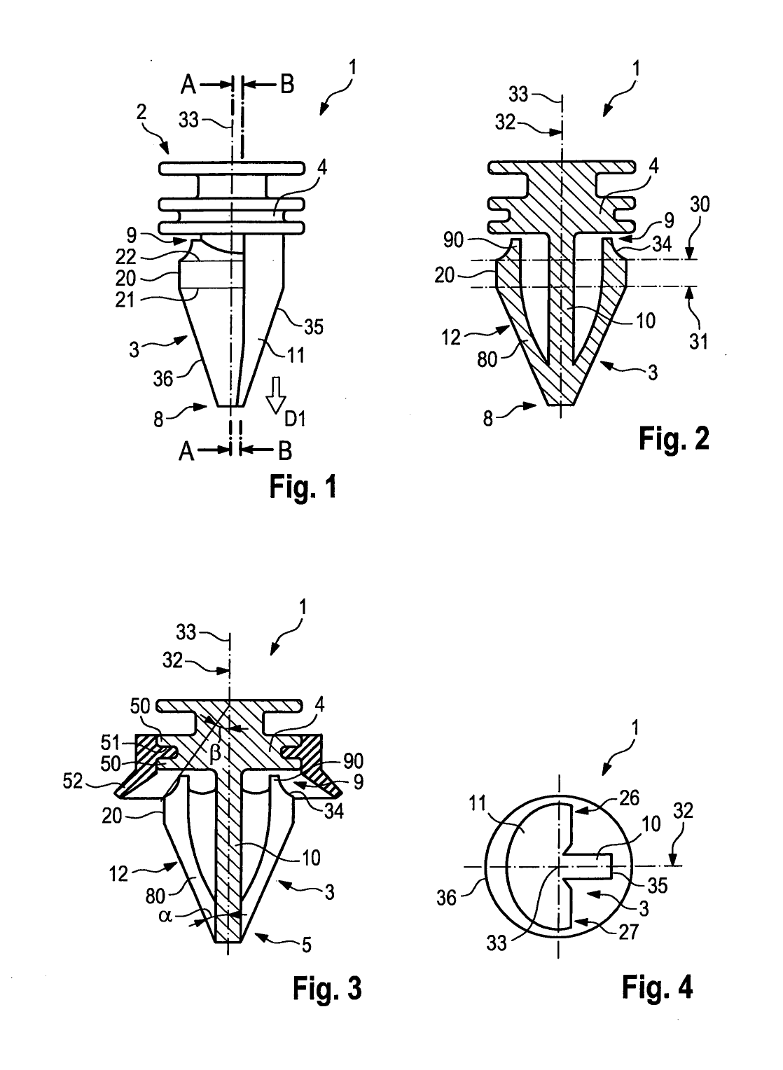

To provide the clip 1 with a maximum compliance and promote the good positioning of the structural element in the constriction 9, the apron 11 preferably extends lengthwise up to the vicinity of the base member 4. To permit a good insertion or a good withdrawal of the clip 1 with respect to an opening of a structure, the apron 11 is formed to be very compliant and includes regions with smaller cross-sections than others and one or more free ends 26, 27 with respect to the base member 4 and the web 10. With this arrangement it is possible to prevent the bundling of bending and/or torsional loads in a single portion of the apron 11, and its durability after numerous mounting and demounting operations is ensured. The presence of free ends 26, 27 provides for transmitting a part of the loads into the circumferential region of the apron 11. In a preferred variant, as shown in FIGS. 1 to 3, the apron 11 extends lengthwise up to near the base member 4, from which it is separated by a space which depends on the thickness of the wall of the structure on which the clip 1 is fixed. It is not desirable that this wall, which in general is formed by a sheet thickness, can slide between the apron 11 and the base member 4. The space between the same thus preferably is smaller than the thickness of the wall for which the clip 1 is provided.

In a further design variant, as shown in FIG. 6, the apron 11 extends lengthwise up to near the base member 4, with which it is only connected at some points, preferably at one or two points, in order to ensure centering of the same, in particular without twisting, with respect to the base member. This fixation only exists at some points, so that one or more free end regions 26, 27 are maintained, to which the loads in the apron 11 can be distributed and where the one or more ends 26, 27 of the apron 11 remain free of movement. In a preferred design of this further variant, a single point of connection between the base member 4 and the apron 11 is located in the extension of the web 10.

In a design variant as shown in the Figures, the web 10 is a central web which is traversed by a longitudinal axis 33 coaxial to the base member 4 and to the head 2 and extends on the side of the head which is opposite to the anchoring end piece 3.

As shown in FIGS. 1 to 3, the apron 11 preferably includes a convex profile 34 at the level of the second portion 90 of the anchoring end piece 3 in the constriction region 5 from the second contact bend 22, which defines the sliding surface 20, to the base member 4, in order to simplify the withdrawal of the clip 1.

This profile 34, which in particular is parabolic, provides for gradually increasing the resistance to the withdrawal of the anchoring end piece 3, until the sliding surface 20 reaches the circumference of the opening of the structural element.

In one design variant, the apron 11 includes a conical profile from the second contact bend 22, which defines the sliding surface 20, to the base member 4, whose opening angle β is smaller than 60 degrees.

As shown in FIG. 3, the base member 4 in a preferred design includes at least one circular lip 50 and/or groove 51 around the axis 33, which is designed such that it can hold a circular or tonic seal 52 or at least a lip 50 which forms this seal, as is shown in FIG. 8.

The web 10 preferably includes a side 35 opposite to the apron 11, whose profile is symmetrical with an outer profile 36, which includes this apron 11, with respect to an axis 33 which corresponds to the direction of insertion or withdrawal, in particular when the profile of the apron 11 has the shape of a double U.

The head 2 is formed in dependence on the use of the clip 1, and its geometry is defined with respect to the same.

The tapered portion 8 of the apron 11 preferably has a thickness which can either be constant or can slightly increase from the tip 5 to the first contact bend 21 which defines the sliding surface 20.

In a preferred embodiment, as shown in FIGS. 7 and 8, the smallest cross-section of the apron 11 according to a longitudinal section through an axis 33 is located at the level of its fixation with the web 10 in the vicinity of the free end 8.

In a preferred variant, the thickness of the apron decreases in the constriction region 9 proceeding from the second contact bend 22 to the end on the side of the base member 4.

In a further variant of the invention the thickness of the bent apron 11 is constant in a cross-section of the anchoring end piece 3, with the exception of at least one bending region 13 with smaller thickness.

The invention is of course not limited to the examples illustrated and described above, which can comprise variants and modifications without departing from the scope of the invention.

1. A retaining clip (1) for fixing an equipment on a structure, comprising a base member (4) which itself has a head (2) or is designed such that it can receive a head (2), wherein on the side opposite to the head (2) proceeding from the base member (4) an anchoring end piece (3) extends with a first portion (80) which has a general shape tapered towards a free end (8) opposite to the base member (4), wherein the first portion (80) continues into a second portion (90) which substantially forms a fixation constriction (9) near the base member (4), wherein an elastically deformable sliding surface (20) extends between the first portion (80) and the second portion (90), with which it is connected via a first contact bend (21) and a second contact bend (22), respectively, which are separated from each other and each protrude at least on a part of their length on the one hand with respect to the sliding region (20) and on the other hand with respect to the first portion (80) or the second portion (90), respectively.

2. The retaining clip according to claim 1, wherein the sliding surface (20) is included in a frustoconical envelope with an opening angle (γ), wherein the angle (γ) is smaller than the opening angle (α) of a frustoconical envelope which is applied to the first contact bend (21) and is tangent to the first portion (80).

3. The retaining clip (1) according to claim 1, wherein the first contact bend (21) and the second contact bend (22) each are contained in separate, parallel planes (30; 31) and with the same each form a cross-section of the anchoring end piece (3), which corresponds to its maximum cross-section.

4. The retaining clip according to claim 1, wherein the first contact bend (21) and the second contact bend (22) extend parallel to each other.

5. The retaining clip according to claim 1, wherein the anchoring end piece (3) extends parallel to an axis (33) and the sectional line between the sliding surface (20) and at least one plane, which extends through the axis (33), is parallel to the same.

6. The retaining clip according to claim 1, wherein the anchoring end piece (3) extends parallel to an axis (33), the tapered portion (80) includes a plane of symmetry (32) which extends through the axis (33), or a plane of symmetry which coincides with the same.

7. The retaining clip (1) according to claim 1, wherein the anchoring end piece (3) extends parallel to its axis (33) and each cross-section of the anchoring end piece (3) has the shape of two joined U.

8. The retaining clip (1) according to claim 1, wherein the anchoring end piece (3) includes a web (10) which proceeds from the base member (4) and extends to the free end (8), from where a halfway circumferential apron (11) extends, and in that the same includes at least one bending region (13) near the web (10), whose cross-section, at each cross-section of the apron, is smaller than the remaining apron (11).

9. The retaining clip (1) according to claim 7, wherein the common leg of the two U forms the web (10).

10. The retaining clip (1) according to claim 8, wherein the thickness of the apron (11) increases from the bending region (13) to a free end (26) which includes the apron (11).

11. The retaining clip (1) according to claim 8, wherein the thickness of the apron (11) at the level of the sliding surface (20) is greater than its thickness outside the sliding surface (20).

12. The retaining clip (1) according to claim 8, wherein the anchoring end piece (3) extends parallel to an axis (33), and at the level of the sliding surface (20) the apron (11) includes an outer and an inner profile, which at each cross-section of the apron (11) extend through a plane extending through the axis parallel to this axis (33), wherein the inner and the outer profile together define the region with the strongest cross-section of the apron (11).

13. The retaining clip (1) according to claim 1, wherein the apron (11) is fixed at the free end (8) and has the shape of a tip (5).

14. The retaining clip (1) according to claim 13, wherein the apron (11) extends according to a conical envelope between the first contact bend (21) and the free end (8).

15. The retaining clip (1) according to claim 8, wherein the apron (11) extends lengthwise up to near the base member (4), from which it is separated by a space.

16. The retaining clip (1) according to claim 8, wherein the apron (11) extends lengthwise up to near the base member (4), on which it is fixed at one or at two points, in order to ensure centering of the same with respect to the base member.

17. The retaining clip (1) according to claim 8, wherein the smallest cross-section of the apron (11) according to a longitudinal section is located at the level of its fixation with the web (10) in the vicinity of the free end (8).

18. The retaining clip (1) according to claim 8, wherein the apron (11) has a convex profile from the second contact bend (22) to the base member (4) or a conical profile from the second contact bend (22) to the base member (4) with the opening angle (β) which is less than 60 degrees.

19. The retaining clip (1) according to claim 1, wherein the base member (4) includes at least one circular lip (50) and/or groove (51) around an axis (33), which is designed such that it can hold a circular or toric seal (52) or at least a lip (50) which forms the seal.

20. The retaining clip (1) according to claim 8, wherein the web (10) has a side (35) pressed against the apron (11) with a profile which with respect to an axis (33) which corresponds to the insertion or withdrawal direction is symmetrical to an outer profile (36) of the apron (11).
